(19) United States
(12) Patent Application Publication
(10) Pub. No.: US 2015/0318650 A1
(43) Pub. Date: Nov. 5, 2015

(54) USB Connector and Wireless Network Access Device

(71) Applicant: Huawei Device Co., Ltd., Shenzhen (CN)

(72) Inventor: Zexu Qian, Shenzhen (CN)

(21) Appl. No.: 14/797,800

(22) Filed: Jul. 13, 2015

Related U.S. Application Data
(63) Continuation of application No. PCT/CN2014/079442, filed on Jun. 9, 2014.

(30) Foreign Application Priority Data
Jun. 9, 2013 (CN) 201310231241.2

(51) Int. Cl. H01R 27/02; H01R 13/66; H04B 7/24

(52) U.S. Cl. CPC H01R 27/02; H04B 7/24; H01R 13/6691

(57) ABSTRACT

A wireless network access device which includes a universal serial bus (USB) connector, the USB connector includes a substrate, a USB signal pin, a subscriber card mounting portion, and a subscriber card data signal pin, where the USB signal pin is disposed on a top of the substrate, and the USB signal pin is connected to a first circuit board, to transmit USB signals; the subscriber card mounting portion is disposed on a bottom of the substrate, to mount a subscriber card; and the subscriber card data signal pin is disposed on the subscriber card mounting portion, and the subscriber card data signal pin is connected to the first circuit board. The present invention achieves an objective of miniaturizing the wireless network access device and reduces impact on the subscriber card caused by heat generated in the wireless network access device. The present invention further provides a USB connector.

### CROSS-REFERENCE

This application is a continuation of International Application PCT/CN2014/079442, filed on Jun. 9, 2014, which claims priority to Chinese Patent Application No. 201310231241.2, filed on Jun. 9, 2013, both of which are hereby incorporated by reference in their entireties.

### TECHNICAL FIELD

The present invention relates to the field of communications, and in particular, to a USB connector and a wireless network access device.

### BACKGROUND

At present, universal serial bus (USB) interfaces have become common standard configuration for personal computers (e.g., desktop computers and portable computers), and are also the most common interfaces for connection to external devices. Wireless network access devices such as wireless Wide Area Network (WAN) cards have been widely applied to personal computers, especially to connections between portable personal computers and wireless networks. A wireless WAN card contains a subscriber card such as a subscriber identity module (SIM) card or a universal subscriber identity module (USIM) card, and accesses a second generation (2G), third generation (3G), or fourth generation (4G) network in a wireless manner. A computer may be connected to the wireless WAN card by means of a USB or the like, to access the Internet, and implement Internet surfing functions such as web page browsing, and sending and receiving of electronic-mail on the computer, thereby meeting a mobile office requirement of a subscriber. Because a subscriber card holder and a subscriber card of a wireless WAN card need to be disposed on a circuit board in the wireless WAN card, some space is occupied, and it is not beneficial to miniaturization of the wireless WAN card.

### SUMMARY

A USB connector and a wireless network access device are provided to reduce a size of the wireless network access device, to achieve an objective of miniaturizing the wireless network access device.

According to a first aspect, a USB connector is provided, and is configured to connect to a first circuit board of a body portion of an electronic device, to transmit signals to the first circuit board, where the USB connector includes a substrate, a USB signal pin, a subscriber card mounting portion, and a subscriber card data signal pin; the USB signal pin is disposed on a top of the substrate, and the USB signal pin is electronically connected to the first circuit board, to transmit USB signals; the subscriber card mounting portion is disposed on a bottom of the substrate, to mount a subscriber card; and the subscriber card data signal pin is disposed in the subscriber card mounting portion, and the subscriber card data signal pin is electronically connected to the first circuit board, so that when the subscriber card is mounted in the mounting portion, subscriber card data signal transmission between the subscriber card and the first circuit board is implemented using the subscriber card data signal pin.

In a first possible implementation manner of the first aspect, the subscriber card mounting portion is a groove, the groove is formed concave inwardly from the bottom of the substrate, and when the subscriber card is mounted in the groove, a data signal pin of the subscriber card is electronically connected to the subscriber card data signal pin in the groove.

With reference to the first possible implementation manner of the first aspect, in a second possible implementation manner, the subscriber card data signal pin is a conductive spring, and when the subscriber card is mounted in the groove, the conductive spring presses against the data signal pin of the subscriber card, to electronically connect to the subscriber card.

In a third possible implementation manner of the first aspect, the subscriber card mounting portion is a subscriber card holder, and the subscriber card holder is electronically connected to the first circuit board using the substrate, so that the subscriber card transmits subscriber card data to the first circuit board using the subscriber card holder and the substrate.

With reference to the third possible implementation manner of the first aspect, in a fourth possible implementation manner, the substrate is a second circuit board extending from the first circuit board, and the subscriber card holder is fastened to a bottom of the second circuit board and is electronically connected to the second circuit board.

With reference to the first aspect or any one of the first to fourth possible implementation manners of the first aspect, in a fifth possible implementation manner, the USB connector further includes a first casing, and the first casing covers the bottom and two sides of the substrate, to assist in positioning of the subscriber card when the subscriber card is mounted in the subscriber card mounting portion.

With reference to the fifth possible implementation manner of the first aspect, in a sixth possible implementation manner, the first casing is provided with a gap; when the subscriber card is mounted in the subscriber card mounting portion, a part of the subscriber card corresponds to the gap; and the subscriber card is pulled out from the subscriber card mounting portion by pulling the part of the subscriber card that corresponds to the gap.

With reference to the fifth or sixth possible implementation manner of the first aspect, in a seventh possible implementation manner, the first casing is further provided with a drive port; when the subscriber card is mounted in the subscriber card mounting portion, a part of the subscriber card corresponds to the drive port; and the drive port drives the part of the subscriber card that corresponds to the drive port, to disengage the subscriber card from the subscriber card mounting portion.

With reference to the first aspect or any one of the first to seventh possible implementation manners of the first aspect, in an eighth possible implementation manner, the USB connector further includes a second casing, and the second casing covers the top of the substrate, to form an accommodating area enclosed by the top of the substrate and the second casing.

With reference to the first aspect or any one of the first to eighth possible implementation manners of the first aspect, in a ninth possible implementation manner, the USB signal pin extends out of a joint of the USB connector to form a USB signal welding pin, to connect to the first circuit board; the subscriber card data signal pin extends out of the joint of the USB connector to form a subscriber card data signal welding pin, to connect to the first circuit board; and the USB signal welding pin and the subscriber card data signal welding pin are located in a same horizontal plane or located in two rows.

According to a second aspect, a wireless network access device is provided, where the device includes a body portion and the USB connector according to the foregoing first aspect and all the possible implementation manners, where the USB connector is disposed at an end of the body portion.

The wireless network access device is provided according to the various implementation manners, where the wireless network access device includes the USB connector and the body portion. The USB connector includes a substrate, a USB signal pin, a subscriber card mounting portion, and a subscriber card data signal pin, where the USB signal pin is disposed on a top of the substrate, and the USB signal pin is electronically connected to the first circuit board, to transmit USB signals; the subscriber card mounting portion is disposed on a bottom of the substrate, to mount a subscriber card; and the subscriber card data signal pin is disposed in the subscriber card mounting portion, and the subscriber card data signal pin is electronically connected to the first circuit board, so that when the subscriber card is mounted in the mounting portion, subscriber card data signal transmission between the subscriber card and the first circuit board is implemented using the subscriber card data signal pin. Therefore, the subscriber card is mounted in the USB connector rather than in the body portion, so that space of the body portion is saved, thereby reducing a size of the wireless network access device, implementing an objective of miniaturizing the wireless network access device, and reducing impact on the subscriber card caused by heat generated in the wireless network access.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show merely some embodiments of the present invention, and a person of ordinary skill in the art may still derive other drawings from these accompanying drawings without creative efforts.

FIG. 1 is a schematic diagram of a state before a wireless network access device is connected to a communications terminal;

FIG. 2 is a schematic diagram of a wireless network access device in which a subscriber card is mounted;

FIG. 3 is a schematic diagram of a longitudinal section of a wireless network access device;

FIG. 4 is a block diagram when a USB connector is connected to a first circuit board;

FIG. 5 is a schematic diagram of a longitudinal section of a USB connector;

FIG. 6 is a schematic diagram of a longitudinal section of a USB connector of a wireless network access device;

FIG. 7 is a schematic diagram of a longitudinal section of a USB connector in which a subscriber card is mounted;

FIG. 8 is a schematic top view of a USB connector;

FIG. 9 is a first schematic cross-sectional diagram of a USB connector; and

FIG. 10 is a second schematic cross-sectional diagram of a USB connector.

### DESCRIPTION OF EMBODIMENTS

The following clearly describes the technical solutions in the embodiments of the present invention with reference to the accompanying drawings in the embodiments of the present invention. The described embodiments are merely some but not all of the embodiments of the present invention. All other embodiments obtained by a person of ordinary skill in the art based on the embodiments of the present invention without creative efforts shall fall within the protection scope of the present invention.

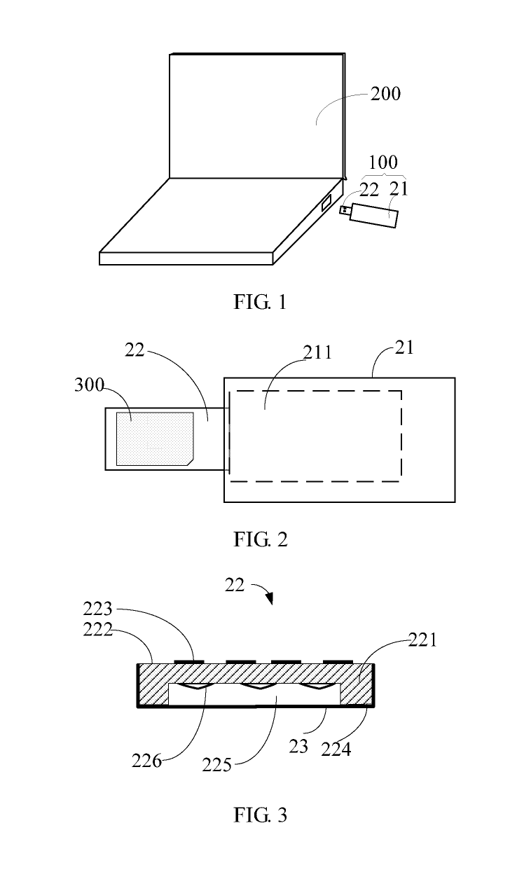

Referring to FIG. 1 and FIG. 2, a first embodiment of the present invention provides a wireless network access device 100. The wireless network access device 100 is configured to connect to a communications terminal 200, to communicate with the communications terminal 200. It should be noted that the present invention is applicable to any electronic device in which a USB connector is mounted and which is capable of reading a subscriber card. The present invention uses a particular electronic device, namely a wireless network access device, for description, but this does not constitute any limitation on application of the present invention to electronic devices except wireless network access devices.

The wireless network access device 100 includes a body portion 21 and a USB connector 22. A first circuit board 211 is disposed in the body portion 21. The USB connector 22 is configured to connect to the first circuit board 211 of the body portion 21 of the wireless network access device 100. The USB connector 22 is disposed at an end of the body portion 21. The USB connector 22 is connected to the first circuit board 211, to transmit signals to the first circuit board 211. In another embodiment, the USB connector 22 may further be configured to connect to a first circuit board of a body portion of another electronic device, to transmit signals to the first circuit board.

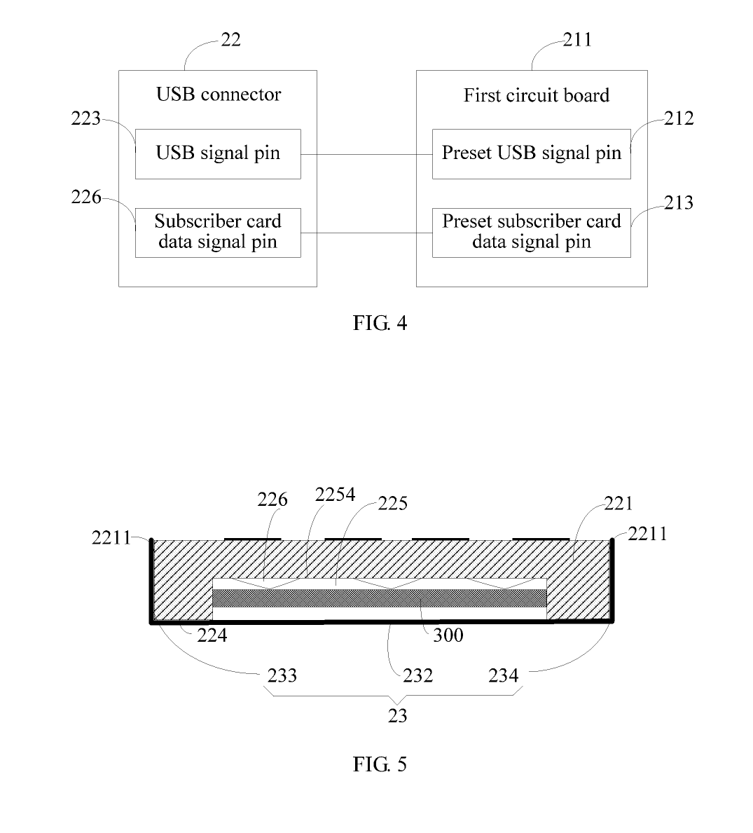

Referring to FIG. 3 and FIG. 4, the USB connector 22 includes a substrate 221, a USB signal pin 223, a subscriber card mounting portion 225, and a subscriber card data signal pin 226. The USB signal pin 223 is disposed on a top 222 of the substrate 221. The USB signal pin 223 is electronically connected to the first circuit board 211, to transmit USB signals. The subscriber card mounting portion 225 is disposed on a bottom 224 of the substrate 221, to mount a subscriber card 300. The top 222 and the bottom 224 are disposed opposite to each other. The subscriber card data signal pin 226 is disposed in the subscriber card mounting portion 225. The subscriber card data signal pin 226 is electronically connected to the first circuit board 211, so that when the subscriber card 300 is mounted in the subscriber card mounting portion 225, subscriber card data signal transmission between the subscriber card 300 and the first circuit board 211 is implemented using the subscriber card data signal pin 226. In this embodiment, the substrate 221 is a plastic body. Optionally, the substrate 221 may also be a circuit board extending from the first circuit board 211.

The first circuit board 211 is provided with a preset USB signal pin 212 and a preset subscriber card data signal pin 213. The USB signal pin 223 of the USB connector 22 is connected to the preset USB signal pin 212, to transmit USB signals. The subscriber card data signal pin 226 of the USB connector 22 is connected to the preset subscriber card data signal pin 213, to transmit subscriber card data signals. In this embodiment of the present invention, the USB signal pin 223 and the subscriber card data signal pin 226 may be connected to an electronic element on the first circuit board 211 using an exposed signal line of the first circuit board 211, may be connected to an electronic element on the first circuit board 211 using an internal line of the first circuit board 211, or may be connected to an electronic element on the first circuit board 211 directly, which is not limited in the present invention.

Referring to FIG. 5, optionally, the subscriber card mounting portion 225 is a groove. The groove is formed concave inwardly from the bottom 224 of the substrate 221. When the subscriber card 300 is mounted in the groove, a data signal pin of the subscriber card 300 is electronically connected to the subscriber card data signal pin 226 in the groove.

Specifically, an angle between a first side wall of the groove and a bottom wall 2254 of the groove is an obtuse angle, to guide the subscriber card 300 to enter or exit from the groove. The first side wall corresponds to a gap 234.

In this embodiment, the subscriber card data signal pin 226 is a conductive spring. When the subscriber card 300 is mounted in the subscriber card mounting portion 225, the conductive spring presses against the data signal pin of the subscriber card 300, to electronically connect to the subscriber card 300. The conductive spring is a hemispherical spring. In another embodiment, the subscriber card data signal pin 226 may be a conductive spring of another shape (such as a bent conductive spring).

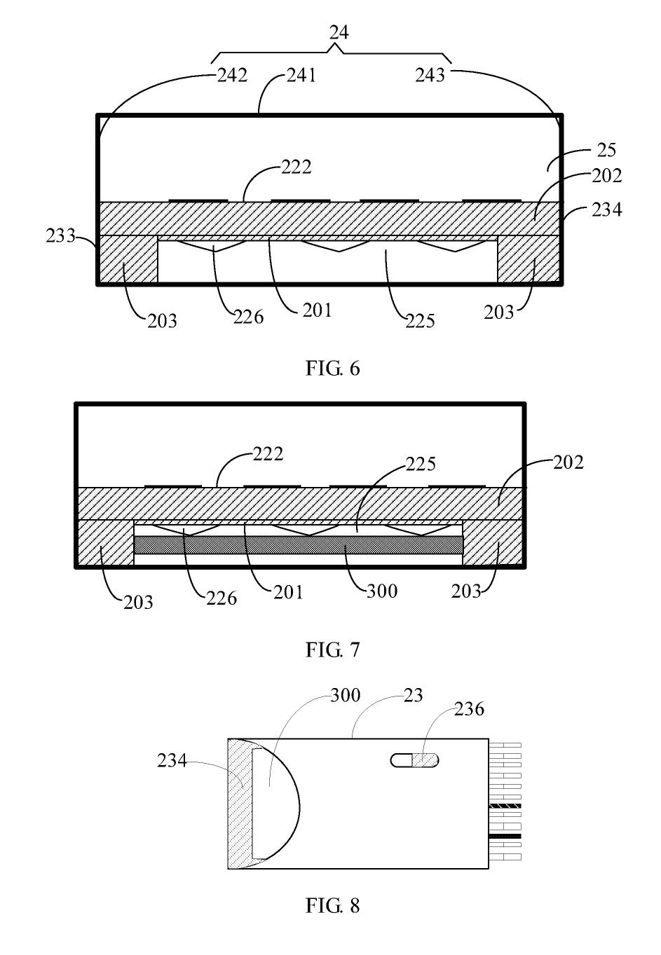

Referring to FIG. 6 and FIG. 7, a second embodiment of the present invention provides a wireless network access device. The wireless network access device provided by the second embodiment is similar to the wireless network access device 100 provided by the first embodiment, and a difference between the two devices lies in that: in the second embodiment, the mounting portion is a subscriber card holder 201. The subscriber card holder 201 is electronically connected to the first circuit board 211 using the substrate 221, so that the subscriber card 300 transmits subscriber card data to the first circuit board 211 using the subscriber card holder 201 and the substrate 221.

Specifically, the substrate 221 is a second circuit board extending from the first circuit board 211. The subscriber card holder 201 is fastened to a bottom of the second circuit board and is electronically connected to the second circuit board. Positioning blocks 203 are disposed on two sides of the subscriber card holder 201 on the bottom of the second circuit board, to position the subscriber card holder 201.

The subscriber card data signal pin 226 is disposed on the subscriber card holder 201, to correspond to a corresponding data signal pin on the subscriber card 300. When the subscriber card 300 is mounted on the subscriber card holder 201, the subscriber card data signal pin 226 is connected to the corresponding data signal pin on the subscriber card 300, so that the subscriber card 300 transmits subscriber card data signals to the first circuit board 211 using the second circuit board.

Optionally, in the foregoing embodiments of the present invention, the USB connector 22 further includes a first casing 23. The first casing 23 covers the bottom 224 and two sides 2211 of the substrate 221, to assist in positioning of the subscriber card 300 when the subscriber card 300 is mounted in the subscriber card mounting portion 225. The subscriber card data signal pin 226 is disposed on the bottom wall 2254 of the groove 225. When the subscriber card 300 is mounted in the groove 225, the subscriber card data signal pin 226 is electronically connected to a corresponding pin of the subscriber card 300, so that the subscriber card 300 transmits subscriber card data signals to the first circuit board 211.

Specifically, the first casing 23 includes a positioning portion 232, and a first connecting portion 233 and a second connecting portion 234 that are formed by bending and extending two sides of the positioning portion 232 upward. The first connecting portion 233 and the second connecting portion 234 are fastened to the two sides 2211 of the substrate 221.

Referring to FIG. 8, optionally, a first end of the positioning portion 232 is provided with the gap 234. When the subscriber card 300 is mounted in the subscriber card mounting portion 225, a part of the subscriber card 300 corresponds to the gap 234. The subscriber card 300 is pulled out from the subscriber card mounting portion 225 by pulling the part of the subscriber card 300 that corresponds to the gap 234.

Optionally, the positioning portion 232 of the first casing 23 is further provided with a drive port 236. When the subscriber card 300 is mounted in the subscriber card mounting portion 225, a part of the subscriber card 300 corresponds to the drive port 236. The drive port 236 drives the part of the subscriber card 300 that corresponds to the drive port 236, to disengage the subscriber card 300 from the subscriber card mounting portion 225.

The USB connector 22 may further include a second casing 24. The second casing 24 covers the top 222 of the substrate 221, to form an accommodating area 25 enclosed by the top 222 of the substrate 221 and the second casing 24, to accommodate and connect to a connecting portion of another USB connector, thereby transmitting USB signals. The second casing 24 includes a limiting portion 241, and a third connecting portion 242 and a fourth connecting portion 243 that are formed by bending and extending two ends of the limiting portion 241. An end of the third connecting portion 242 is disposed on an end of the first connecting portion 233. An end of the fourth connecting portion 243 is disposed on an end of the second connecting portion 234.

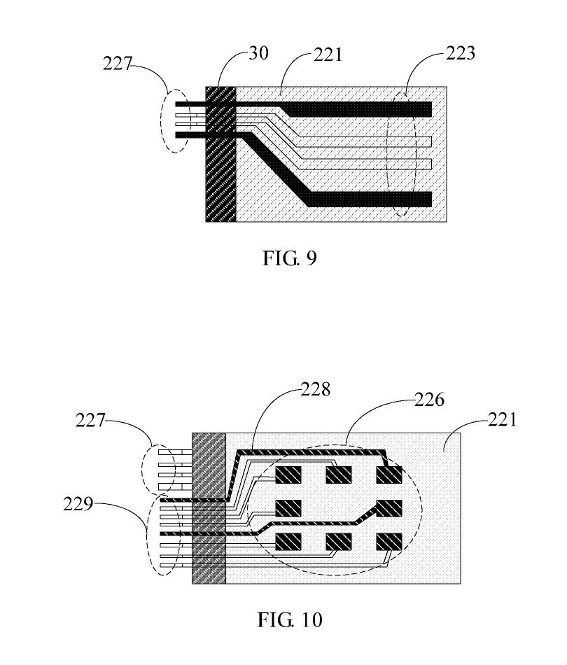

Referring to FIG. 9 and FIG. 10, optionally, the USB signal pin 223 is bent and extends out of a joint 30 of the USB connector 22, to form a USB signal welding pin 227, to connect to the first circuit board 211. The subscriber card data signal pin 226 extends out of the joint 30 of the USB connector 22 to form a subscriber card data signal welding pin 229, to connect to the first circuit board 211. The USB signal welding pin 227 and the subscriber card data signal welding pin 229 may be located in a same horizontal plane, to reduce a thickness of the USB connector 22. The USB signal welding pin 227 and the subscriber card data signal welding pin 229 may not be located in a same horizontal plane. For example, the USB signal welding pin 227 and the subscriber card data signal welding pin 229 may be located in two rows, thereby reducing a width of the USB connector 22. That is, a manner of disposing the USB signal welding pin 227 and the subscriber card data signal welding pin 229 may be adjusted according to an actual requirement.

In another embodiment, the USB connector 22 may further include a connecting line 228. The subscriber card data signal pin 226 is connected to a first end of the connecting line 228. A second end of the connecting line 228 extends out of the joint 30 of the USB connector 22 to form the subscriber card data signal welding pin 229, to connect to the first circuit board 211.

In this embodiment of the present invention, optionally, the wireless network access device 100 is a wireless WAN card. The subscriber card 300 is a Nano SIM card. A length of the Nano SIM card is 12.3 millilmeter±0.1 millimeter. A width of the Nano SIM card is 8.8 mm±0.1 mm. A thickness of the Nano SIM card is about 0.65 mm. A length of the USB connector 22 is 14 mm. The width of the USB connector 22 is 12 mm. The thickness of the USB connector 22 is 4.5 mm.

In the foregoing embodiment, the USB connector 22 of the wireless network access device 100 includes a substrate 221, a USB signal pin 223, a subscriber card mounting portion 225, and a subscriber card data signal pin 226. The USB signal pin 223 is disposed on a top 222 of the substrate 221. The USB signal pin 223 is electronically connected to the first circuit board 211, to transmit USB signals. The subscriber card mounting portion 225 is disposed on a bottom 224 of the substrate 221, to mount a subscriber card 300. The subscriber data signal pin 226 is disposed on the subscriber card mounting portion 225. The subscriber card data signal pin 226 is electronically connected to the first circuit board 211, so that when the subscriber card 300 is mounted in the subscriber card mounting portion 225, subscriber card data signal transmission between the subscriber card 300 and the first circuit board 211 is implemented using the subscriber card data signal pin 226. Therefore, the subscriber card 300 is mounted in the USB connector 22 rather than in the body portion 21, so that space of the body portion 21 is saved, thereby reducing a size of the wireless network access device 100, implementing an objective of miniaturizing the wireless network access device 100, and reducing impact on the subscriber card 300 caused by heat generated in the wireless network access 100.

What is disclosed above is merely exemplary embodiments of the present invention, and certainly is not intended to limit the protection scope of the present invention. A person of ordinary skill in the art may understand that all or some of processes that implement the foregoing embodiments and equivalent modifications made in accordance with the claims of the present invention shall fall within the scope of the present invention.

What is claimed is:

1. A universal serial bus (USB) connector comprising:
a substrate;
a USB signal pin disposed on a top of the substrate;
a subscriber card mounting portion disposed on a bottom of the substrate; and
a subscriber card data signal pin disposed in the subscriber card mounting portion,
wherein the USB connector is configured to connect to a first circuit board of a body portion of an electronic device to transmit signals to the first circuit board,
wherein the USB signal pin is electronically connected to the first circuit board and configured to transmit USB signals,
wherein the subscriber card mounting portion is configured to mount a subscriber card,
wherein the subscriber card data signal pin is electronically connected to the first circuit board to implement, when the subscriber card is mounted in the subscriber card mounting portion, subscriber card data signal transmission between the subscriber card and the first circuit board using the subscriber card data signal pin.

2. The USB connector according to claim 1, wherein the subscriber card mounting portion is a groove, wherein the groove is formed concave inwardly from the bottom of the substrate, and wherein, when the subscriber card is mounted in the groove, a data signal pin of the subscriber card is electronically connected to the subscriber card data signal pin in the groove.

3. The USB connector according to claim 2, wherein the subscriber card data signal pin is a conductive spring, and wherein, when the subscriber card is mounted in the groove, the conductive spring presses against the data signal pin of the subscriber card to electronically connect to the subscriber card.

4. The USB connector according to claim 1, wherein the subscriber card mounting portion is a subscriber card holder, and wherein the subscriber card holder is electronically connected to the first circuit board using the substrate to facilitate the subscriber card transmitting subscriber card data to the first circuit board using the subscriber card holder and the substrate.

5. The USB connector according to claim 4, wherein the substrate is a second circuit board extending from the first circuit board, and wherein the subscriber card holder is fastened to a bottom of the second circuit board and is electronically connected to the second circuit board.

6. The USB connector according to claim 1, further comprising a first casing covering the bottom and two sides of the substrate, wherein the first casing is configured to assist in positioning the subscriber card when the subscriber card is mounted in the subscriber card mounting portion.

7. The USB connector according to claim 6, wherein the first casing is provided with a gap, wherein, when the subscriber card is mounted in the subscriber card mounting portion, a part of the subscriber card corresponds to the gap, and wherein the subscriber card is removed from the subscriber card mounting portion by pulling the part of the subscriber card that corresponds to the gap.

8. The USB connector according to claim 6, wherein the first casing is further provided with a drive port, wherein, when the subscriber card is mounted in the subscriber card mounting portion, a part of the subscriber card corresponds to the drive port, wherein the drive port drives the part of the subscriber card that corresponds to the drive port, and wherein the drive port is configured to disengage the subscriber card from the subscriber card mounting portion.

9. The USB connector according to claim 1, further comprising a second casing covering the top of the substrate, wherein the second casing is configured to form an accommodating area enclosed by the top of the substrate and the second casing.

10. The USB connector according to claim 1, wherein the USB signal pin, to connect to the first circuit board, extends out of a joint of the USB connector to form a USB signal welding pin, and wherein the subscriber card data signal pin, to connect to the first circuit board, extends out of the joint of the USB connector to form a subscriber card data signal welding pin.

11. The USB connector according to claim 10, wherein the USB signal welding pin and the subscriber card data signal welding pin are located in a same horizontal plane.

12. The USB connector according to claim 10, wherein the USB signal welding pin and the subscriber card data signal welding pin are located in two rows.

13. The USB connector according to claim 1, wherein the USB connector is disposed at an end of a body portion of a wireless network access device.
